(19) United States
(12) Patent Application Publication
(10) Pub. No.: US 2022/0139220 A1
(43) Pub. Date: May 5, 2022

(54) METHOD AND APPARATUS FOR DETECTING LIGHT STATE DATA

(71) Applicant: Apollo Intelligent Connectivity (Beijing) Technology Co., Ltd., BEIJING (CN)

(72) Inventor: GAO YU, BEIJING (CN)

(21) Appl. No.: 17/578,419

(22) Filed: Jan. 18, 2022

(30) Foreign Application Priority Data
May 27, 2021 (CN) 202110587590.2

(51) Int. Cl. G08G 1/097; G08G 1/083

(52) U.S. Cl. CPC G08G 1/097; G08G 1/083

(57) ABSTRACT

The present disclosure provide a method and an apparatus for detecting light state data, which includes: acquiring light state data of traffic lights, and acquiring control information of the traffic lights, where the light state data includes period time information and/or phase sequence information, the period time information characterizes time information of lighting each light holder in the traffic lights in a period, the phase sequence information characterizes a green light order of each phase corresponding to the traffic lights; and the control information characterizes a control rule of the traffic lights; and performing consistency matching between the light state data and the control information to obtain a first matching result, and determining a detection result of the light state data according to the first matching result.

### CROSS-REFERENCE TO RELATED APPLICATIONS

The present application claims priority to Chinese Patent Application No. 202110587590.2, filed on May 27, 2021, which is hereby incorporated by reference in its entirety.

### TECHNICAL FIELD

The present disclosure relates to the field of intelligent traffic and automatic driving technologies in the field of artificial intelligence technologies, and in particular, to a method and an apparatus for detecting light state data.

### BACKGROUND

With advancement of urbanization and development of traffic intelligence technologies, light state data of traffic lights is widely used, such as in traffic information release, in traffic information optimization, etc., but how to detect the light state data has become an urgent problem to be solved.

In the related art, a commonly used method for detecting light state data includes: light state data is collected; a detection rule is formulated according to the light state data in a previous time period, for example, the light state data of the first half hour is projected on an absolute time axis of twenty-four hours a day; based on the time axis, missing and repeating conditions of the light state data in a subsequent time period are determined; and a detection result of the light state data is determined according to the missing and repeating conditions.

### SUMMARY

According to a first aspect of the present disclosure, provided is a method for detecting light state data, including:

acquiring light state data of traffic lights, and acquiring control information of the traffic lights, where the light state data includes period time information and/or phase sequence information; the period time information characterizes time information of lighting each light holder in the traffic lights in a period; the phase sequence information characterizes a green light order of each phase corresponding to the traffic lights; and the control information characterizes a control rule of the traffic lights; and performing consistency matching between the light state data and the control information to obtain a first matching result, and determining a detection result of the light state data according to the first matching result.

According to a second aspect of the present disclosure, provided is an electronic device, including:

at least one processor; and

a memory communicatively coupled to the at least one processor; where

the memory stores instructions executable by the at least one processor, and the instructions are executed by the at least one processor to enable the at least one processor to: acquire light state data of traffic lights, and acquire control information of the traffic lights, wherein the light state data comprises period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and perform consistency matching between the light state data and the control information to obtain a first matching result, and determine a detection result of the light state data according to the first matching result.

According to a third aspect of the present disclosure, provided is a non-transitory computer readable storage medium storing computer instructions, where the computer instructions are used for causing a computer to: acquire light state data of traffic lights, and acquire control information of the traffic lights, wherein the light state data comprises period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and perform consistency matching between the light state data and the control information to obtain a first matching result, and determine a detection result of the light state data according to the first matching result.

It should be understood that, the content described in this section is not intended to identify key or important features of embodiments of the present disclosure, nor is it intended to limit scope of the present disclosure. Other features of the present disclosure will be easy to understand from the following description.

### BRIEF DESCRIPTION OF DRAWINGS

The accompanying drawings are used for better understanding of the present solution and do not constitute a limitation to the present disclosure, where:

FIG. 1 is a schematic diagram according to a first embodiment of the present disclosure;

FIG. 2 is a schematic diagram of an application scenario of a method for detecting light state data according to an embodiment of the present disclosure;

FIG. 3 is a schematic diagram according to a second embodiment of the present disclosure;

FIG. 4 is a schematic diagram according to a third embodiment of the present disclosure;

FIG. 5 is a schematic diagram according to a fourth embodiment of the present disclosure;

FIG. 6 is a schematic diagram according to a fifth embodiment of the present disclosure;

FIG. 7 is a schematic diagram according to a sixth embodiment of the present disclosure; and

FIG. 8 is a block diagram of an electronic device for implementing a method for detecting light state data according to an embodiment of the present disclosure.

### DESCRIPTION OF EMBODIMENTS

Exemplary embodiments of the present disclosure are described below in conjunction with accompanying drawings, where various details of embodiments of the present disclosure are included to facilitate understanding, and they should be considered as merely exemplary. Accordingly, persons of ordinary skill in the art will recognize that various changes and modifications may be made to the embodiments described herein without departing from the scope and spirit of the present disclosure. Likewise, for clarity and conciseness, description of well-known functions and structures is omitted in the following description.

A traffic signal machine is one of important components of modern urban traffic systems, and is mainly used for control and management of urban road traffic signals. The traffic signal machine is composed of multiple function module plug-in boards including a main liquid crystal display screen, a central processing unit (CPU) board, a control board, a light group drive board with optocoupler isolation, a switching power supply, a button board, etc., and a power distribution board, a terminal block, etc.

The traffic signal machine includes at least one light holder, each light holder can display different colors and time, etc., and the traffic signal machine is configured to indicate travel-related data of a vehicle and/or a pedestrian, which can be referred to as light state data, that is, the light state data can be understood as data that provides indication for the travel of the vehicle and/or the pedestrian from a time dimension, a color dimension, and a direction dimension, etc.

Illustratively, the light state data is usually used for traffic information release, traffic information control, traffic information optimization, and the like, and it is necessary to detect the light state data in order to improve travel reliability and security and the like of the vehicle and/or the pedestrian.

In the related technology, a commonly used method for detecting light state data includes: light state data in a first time period is collected firstly; a detection rule is formulated according to the light state data in the first time period, for example, the light state data of the first half hour (namely, the first time period) is projected on an absolute time axis of twenty-four hours a day; based on the time axis, missing and repeating conditions of the light state data in a second time period (for a time period after the first time period) are determined; and a detection result of the light state data is determined according to the missing and repeating conditions.

However, on the one hand, since the detection rule is formulated based on the light state data in the first time period, accuracy and reliability and the like of the light state data in the first time period are uncertain, therefore, the accuracy and reliability of the detection rule specified based on the light state data in the first time period are uncertain, thus, when the light state data in the second time period is detected based on the detection rule, there may be a technical problem of low detection accuracy and reliability. On the other hand, since the light state data is processed in segments, and part of the light state data is detected (namely, the light state data in the second time period is detected), a detection has shortcomings of lacking comprehensiveness, which may lead to a technical problem of low detection accuracy.

In order to avoid at least one of the described technical problems, inventors of the present disclosure, through creative efforts, have obtained the inventive concept of the present disclosure: consistency between the light state data and control information is matched, and a detection result is determined based on a matching result.

The present disclosure provides a method and an apparatus for detecting light state data, which are applied to the technical field of intelligent traffic and automatic driving in the field of artificial intelligence technologies to achieve the accuracy and reliability of detecting light state data.

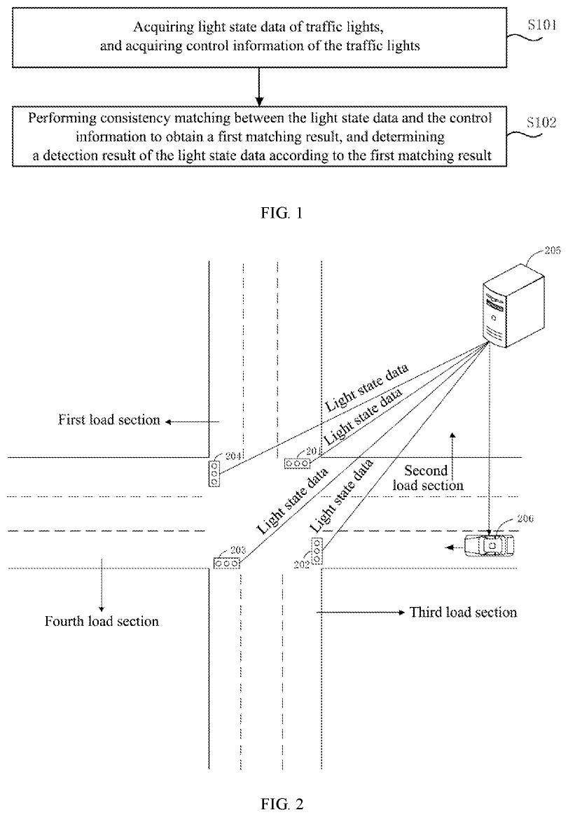

FIG. 1 is a schematic diagram according to a first embodiment of the present disclosure, as shown in FIG. 1, a method for detecting light state data according to an embodiment of the present disclosure includes:

S101: acquiring light state data of traffic lights, and acquiring control information of the traffic lights.

The light state data includes period time information and/or phase sequence information; the period time information characterizes time information of lighting each light holder in the traffic lights in a period; the phase sequence information characterizes a green light order of each phase corresponding to the traffic lights; and the control information characterizes a control rule of the traffic lights.

Illustratively, the execution entity of the present embodiment may be an apparatus for detecting light state data (hereinafter referred to as a detection apparatus), and the detection apparatus may be a server (including a local server and a cloud server, and the server may be a cloud control platform, a vehicle-road collaborative management platform, a central subsystem, an edge computing platform, a cloud computing platform, etc.), it may also be a roadside device, a terminal device, a processor, a chip, etc., which are not limited in the present embodiment.

The roadside device includes, for example, a roadside perception device having a computing function and a roadside computing device connected to the roadside perception device. In a system architecture of intelligent traffic vehicle-road collaboration, the roadside device includes a roadside perception device and a roadside computing device, the roadside perception device (for example, a roadside camera) is connected to the roadside computing device (for example, a roadside computing unit RSCU), the roadside computing device is connected to the server, and the server may communicate with an automatic driving vehicle or an assisting driving vehicle in various ways; or, the roadside perception device itself includes a computing function, and the roadside perception device is directly connected to the server. The above connections may be wired or wireless.

It should be noted that, in the present embodiment, a manner in which the detection apparatus acquires the light state data is not limited. For example:

in one example, the detection apparatus may be connected to a first platform that manufactures traffic lights and receives light state data transmitted by the first platform.

In another example, the detection apparatus may also be connected to a second platform that controls traffic lights and receives light state data transmitted by the second platform.

S102: performing consistency matching between the light state data and the control information to obtain a first matching result, and determining a detection result of the light state data according to the first matching result.

In combination with the above analysis, in one example, this step can be understood as follows: the detection apparatus performs consistency matching between the period time information and the control information to obtain a first matching result, and determines a detection result based on the first matching result.

In another example, this step may also be understood as follows: the detection apparatus performs consistency matching between the phase sequence information and the control information to obtain a first matching result, and determines a detection result based on the first matching result.

In yet another example, this step may be understood as follows: the detection apparatus performs consistency matching between the period time information and the control information to obtain a first sub-matching result, performs consistency matching between the phase sequence information and the control information to obtain a second sub-matching result, and determines a detection result based on the first sub-matching result and the second sub-matching result.

That is to say, the detection result may be determined based on the consistency between the period time information and the control information, or may be determined based on the consistency between the phase sequence information and the control information, or may be determined based on results of the foregoing two consistencies.

In some embodiments, if the detection result is determined based on the first sub-matching result and the second sub-matching result, the detection apparatus may pre-assign weight coefficients to the first sub-matching result and the second sub-matching result, so as to determine the detection result based on the first sub-matching result, the second sub-matching result, and the respectively corresponding weight coefficient.

Based on the above analysis, it can be seen that, the present embodiment provides a method for detecting light state data, including: acquiring light state data of traffic lights, and acquiring control information of the traffic lights, where the light state data includes period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and performing consistency matching between the light state data and the control information to obtain a first matching result, and determining a detection result of the light state data according to the first matching result. In the present embodiment, features of determining the first matching result obtained by the consistency matching between the light state data and the control information, and determining the detection result based on the first matching result are introduced, so as to avoid disadvantage in the related technology that determining the detection result of part of the light state data as a whole detection result, which may cause the detection result to be one-sided, lack of accuracy and reliability. Whereas a manner of determining the detection result based on the first matching result obtained by the consistency matching between the light state data and the control information is adopted, which can achieve the technical effect that improving comprehensiveness and integrity of detecting the light state data when the consistency matching is performed between the light state data and the control information, thereby improving the comprehensiveness and accuracy of the detection.

In conjunction with the above analysis, it can be seen that, the light state data can be used for indicating the travel of the vehicle and/or the pedestrian, and the method for detecting light state date in the present embodiment has high accuracy and reliability, therefore, when the light state data is specifically applied, the light state data may be detected firstly, and when a detection result meets a preset application requirement, the light state data is applied, thereby improving the reliability of the application of the light state data and satisfying travel demands of the vehicle and/or the pedestrian.

For example, the detection result may characterize accuracy of the quality of the light state data, and if it is determined through the detection result that the accuracy of the quality of the light state data is greater than a preset accuracy requirement, traffic information may be released based on the light state data, for example, the traffic information may be released in a map, so that when the vehicle is traveling based on the map, a traffic failure load section can be avoided timely, and a new path can be planned in advance, thereby achieving the technical effect of improving traveling security.

By the same reasoning, the light state data satisfying the accuracy requirement may also be displayed on electronic devices such as a DuMirror and a traffic signal control screen and the like, so as to achieve the technical effect of improving traveling security of the vehicle and/or pedestrian.

As shown in FIG. 2, an intersection may be composed of a first load section, a second load section, a third load section, and a fourth load section. The first load section and the third load section may be referred to as load sections facing each other, and the second load section and the fourth load section may be referred to as load sections facing each other. Traffic light 201 disposed at the first load section are used for indicating traveling of a vehicle on the third load section according to the corresponding light state data. Traffic light 202 disposed at the second load section are used for indicating traveling of a vehicle on the fourth load section according to the corresponding light state data. Traffic light 203 disposed at the third load section are used for indicating traveling of a vehicle on the first load section according to the corresponding light state data. Traffic light 204 disposed at the fourth load section are used for indicating traveling of a vehicle of the second load section according to the corresponding light state data.

A server 205 may acquire light state data of at least one of traffic lights in the traffic light 201, the traffic light 202, the traffic light 203, and the traffic light 204, and perform a detection on the acquired light state data by using the method for detecting light state data provided by the present embodiment to obtain a detection result; and when the detection result satisfies a preset application requirement (for example, it may be the accuracy requirement described above), the light state data is displayed on the map, and the map which includes the light state data is pushed to a vehicle 206, so that the vehicle 206 executes a corresponding driving strategy according to the map which includes the light state data, such as replanning the driving route and the like.

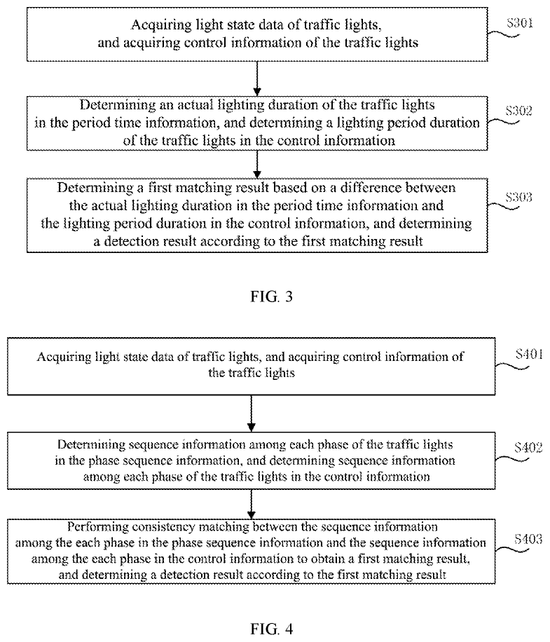

FIG. 3 is a schematic diagram according to a second embodiment of the present disclosure. As shown in FIG. 3, a method for detecting light state data according to an embodiment of the present disclosure includes:

S301: acquiring light state data of traffic lights, and acquiring control information of the traffic lights.

The light state data includes period time information, the period time information characterizes time information of lighting each light holder in the traffic lights in a period, and the control information characterizes a control rule of the traffic lights.

Illustratively, with regard to the implementation principle of S301, reference may be made to the description of S101, and details are not described herein again.

S302: determining an actual lighting duration of the traffic lights in the period time information, and determining a lighting period duration of the traffic lights in the control information.

In the period time information, the traffic lights may not be turned on during the whole period, but only a part of the time is turned on, that is, an actual running duration of the traffic lights may be less than a period time, and the actual lighting duration in this step is a duration for which the traffic lights is actually turned on in the period time corresponding to the period time information.

S303: determining a first matching result based on a difference between the actual lighting duration in the period time information and the lighting period duration in the control information, and determining a detection result according to the first matching result.

Illustratively, if the actual lighting duration in the period time information is t1, and the lighting period duration in the control information is t2, the difference between the both is (t1−t2), and the detection apparatus may determine the first matching result based on (t1−t2).

The first matching result and (t1−t2) are of an inversely proportional relationship, that is, the larger (t1−t2) is, the smaller the first matching result is (namely, the lower the consistency matching is); otherwise, the smaller (t1−t2) is, the larger the first matching result is (namely, the higher the consistency matching is).

If the detection result is a detection result characterizing the quality of the light state data, the larger the first matching result is, the better the quality characterized by the detection result is, that is, the light state data is high-quality light state data; otherwise, the smaller the first matching result is, the worse the quality characterized by the detection result is, that is, the light state data is low-quality light state data.

It should be noted that, in the present embodiment, by determining the detection result based on (t1−t2), it is possible to characterize the integrity of the period time information by the detection result, that is, it is possible to characterize the integrity of the light state data, and it is possible to characterize the consistency between the light state data and the control information by the detection result, and therefore, the technical effect of improving the accuracy and reliability of the detection result can be achieved.

In some embodiments, S302 and S303 may be replaced by: determining a lighting period duration of the traffic lights in the period time information, determining a lighting period duration of the traffic lights in the control information, determining a first matching result based on a difference between the lighting period duration in the period time information and the lighting period duration in the control information, and determining a detection result according to the first matching result.

For example, if the lighting period duration which is determined according to the period time information is t3, and the lighting period duration which is determined according to the control information is t2, the first matching result may be determined according to (t3−t2). The first matching result and (t3−t2) are of an inversely proportional relationship, that is, the larger (t3−t2) is, the smaller the first matching result is (namely, the lower the consistency matching is); otherwise, the smaller (t3−t2) is, the larger the first matching result is (namely, the higher the consistency matching is).

By the same reasoning, in the present embodiment, by determining the detection result based on (t3−t2), it is possible to characterize the consistency between the light state data and the control information by the detection result, therefore, the technical effect of improving the accuracy and reliability of the detection result can be achieved.

It should be noted that, each embodiment in the present embodiment may be implemented separately, or may be combined into one embodiment, and when a plurality of embodiments are combined, a weight coefficient may be assigned to a matching result obtained in each embodiment, and a detection result may be determined based on each matching result and each weight coefficient.

In some embodiments, the period time information includes lighting time information of the traffic lights and a lighting period duration of the traffic lights; the determining a detection result of the light state data according to the first matching result includes the following steps.

A first step: determining a first degree of confidence of the period time information according to the lighting time information in the period time information and the lighting period duration in the period time information, where the first degree of confidence characterizes accuracy and/or integrity of the lighting time information in the period time information.

A second step: determining the detection result according to the first matching result and the first degree of confidence.

In the present embodiment, it can be understood that, the detection apparatus can determine the accuracy and/or integrity of the period time information itself, that is, determine the first degree of confidence, and obtain the detection result by combining the first matching result and the first degree of confidence. Of course, determining the detection result based on the first degree of confidence of the period time information may be a separate embodiment, and the present disclosure is not limited thereto.

It should be noted that, in the present embodiment, the detection result is determined by combining the first matching result which characterizes the consistency between light state information and the control information and the first degree of confidence which characterizes the accuracy and/or the integrity of the light state information, thus, it is possible to detect the light state data from a plurality of dimensions, thereby achieving the technical effect of comprehensiveness and accuracy of the detection result.

In an example, the first step may include: determining an actual lighting duration of the traffic lights according to the lighting time information in the period time information, computing first difference information between the actual lighting duration of the traffic lights and the lighting period duration in the period time information, and determining the first degree of confidence according to the first difference information.

For example, the actual lighting duration of the traffic lights is an actual lighting duration of the traffic lights in a period, and the first difference information may be expressed as (the actual lighting duration of the traffic lights—the lighting period duration in the period time information).

In another example, the actual lighting duration of the traffic lights is an actual lighting duration of the traffic lights in a period, and the first difference information may be expressed as (the actual lighting duration of the traffic lights-a step), where the step is countdown seconds, for example, if the countdown goes from m seconds to n seconds, the step is (m-n).

In yet another example, the actual lighting duration of the traffic lights is (the lighting period duration in the period time information-time of the start of the countdown), and the first difference information may be expressed as ((the lighting period duration in the period time information-the time of the start of the countdown)/the lighting period duration in the period time information).

In still another example, the actual lighting duration of the traffic lights is remaining time at the end of the countdown, and the first difference information may be expressed as (the remaining time at the end of the countdown/the lighting period duration in the period time information).

It should be noted that, in the present embodiment, the first degree of confidence is determined by the first difference information, and specifically, the first difference information is determined by the actual lighting duration of the traffic lights and the lighting period duration in the period time information, and it is possible to enable the first degree of confidence to reliably characterize the accuracy and/or the integrity of the light state data, thus, the technical effect of improving the accuracy and reliability of the first degree of confidence can be achieved.

In another example, the first step may include: determining a first number of abnormal hopping seconds of time information of the traffic lights according to the lighting time information in the period time information, computing a first ratio between the first number of abnormal hopping seconds and the lighting period duration in the period time information, and determining the first degree of confidence according to the first ratio.

For example, the first number of abnormal hopping seconds may be a sum of the number of the abnormal hopping seconds in a period, and the abnormal hopping may be understood as: when the countdown is eighty-nine seconds, it should have jumped to eighty-eight seconds firstly but jump to eighty-seven seconds, then it is determined that the number of abnormal hopping seconds is one second, and so on. The sum of the number of abnormal hopping seconds in the entire period is determined, and the first ratio may be expressed as (the sum of the number of abnormal hopping seconds in the period/the lighting period duration in the period time information).

In another example, the first abnormal hopping seconds may be a sum of the number of unchanged seconds in a period, and the number of the unchanged seconds may be understood as: when the countdown is eighty-nine seconds, it should have jumped to eighty-eight seconds firstly, but still hold eighty-nine seconds, and the number of unchanged seconds is one second, and so on. The sum of the number of unchanged seconds in the entire period is determined, and the first ratio may be expressed as (the sum of the number of unchanged seconds in the period/the lighting period duration in the period time information).

In yet another example, the first abnormal hopping seconds may be a sum of the number of non-monotonically decreasing seconds in a period, and the number of the non-monotonically decreasing seconds may be understood as: when the countdown is eighty-nine seconds, it should have jumped to eighty-eight seconds firstly, but jump to ninety seconds, and then jump to eighty-eight seconds, then it is determined that the number of non-monotonically decreasing seconds in the period is one second, and so on. The sum of the number of non-monotonically decreasing seconds in the entire period is determined, and the first ratio may be expressed as (the sum of the number of non-monotonically decreasing seconds in the period/the lighting period duration in the period time information).

By the same reasoning, in the present embodiment, the first degree of confidence is determined by using the number of the first abnormal hopping seconds, it is possible to enable the first degree of confidence to accurately characterize a hopping situation of the traffic lights, thereby the technical effect of improving the accuracy and reliability of the first degree of confidence can be achieved.

FIG. 4 is a schematic diagram according to a third embodiment of the present disclosure, and as shown in FIG. 4, a method for detecting light state data according to an embodiment of the present disclosure includes:

S401: acquiring light state data of traffic lights, and acquiring control information of the traffic lights.

The light state data includes phase sequence information, the phase sequence information characterizes a green light order of each phase corresponding to the traffic lights, and the control information characterizes a control rule of the traffic lights.

Illustratively, with regard to implementation principle of S401, reference may be made to description of S101, and details are not described herein again.

S402: determining sequence information among each phase of the traffic lights in the phase sequence information, and determining sequence information among phases of the traffic lights in the control information.

S403: performing consistency matching between the sequence information among the each phase in the phase sequence information and the sequence information among the each phase in the control information to obtain a first matching result, and determining a detection result according to the first matching result.

For example, if the sequence information among the each phase in the phase sequence information is a left turn phase, a straight phase and a right turn phase, the sequence information among the each phase in the control information is a left turn phase, a right turn phase and a straight phase, then it shows that the consistency of the both is low, and the first matching result is relatively small.

On the contrary, if the sequence information among the each phase in the phase sequence information is a left turn phase, a straight phase and a right turn phase, and the sequence information among the each phase in the control information is a left turn phase, a straight phase and a right turn phase, then it shows that the consistency of the both is high (full matching), and the first matching result is relatively large.

It should be noted that, in the present embodiment, the detection result is determined by the matching result of consistency matching which is performed between the sequence information among the each phase in the phase sequence information and the sequence information among the each phase in the control information, it is possible to enable the detection result to characterize the consistency of the phase sequence information between the light state data and the control information, thus, the detection result is a comparable detection result and a reliable detection result, therefore, the detection result can have technical effects of high reliability and accuracy.

In some embodiments, S402 and S403 may be replaced by: determining a lighting duration of each lighting color of the traffic lights in the phase sequence information, determining a lighting duration of each lighting color of the traffic lights in the control information, and performing consistency matching between the lighting duration in the phase sequence information and the lighting duration in the control information to obtain the first matching result.

In the present embodiment, it can be understood that, the detection apparatus compares the contents from two dimensions (the contents from the two dimensions have a high association) in the light state data and the control information, and the content of one dimension is lighting color (for example, yellow light, green light, red light), and the content of the another dimension is lighting duration of the lighting color (for example, a lighting duration of yellow light is ten seconds).

By the same reasoning, in the present embodiment, the detection result is determined by the matching result of consistency between the lighting duration in the phase sequence information and the lighting duration in the control information, so that the detection result can have technical effects of high accuracy and reliability.

In an example, the determining a detection result according to the first matching result may include the following steps.

A first step: determining each phase in the phase sequence information, and determining each phase of the traffic lights in a preset traffic network, and performing consistency matching between each phase in the phase sequence information and each phase in the preset traffic network to obtain a second matching result.

The traffic network refers to a network structure which is constructed based on traffic lights disposed at an intersection, the traffic network includes a plurality of nodes, each node has an associated property between the traffic lights and the intersection, and each node has a phase property.

Correspondingly, this step can be understood as follows: the detection apparatus compares each phase in the phase sequence information with each phase in the traffic network, and determines whether each phase in the phase sequence information is consistent with each phase in the traffic network, thereby obtaining the second matching result.

A second step: determining the detection result according to the first matching result and the second matching result.

It should be noted that, in the present embodiment, accuracy of each phase in the light state data is determined by combining the traffic network, so as to determine the detection result in combination with an accurate result (namely, the second matching result), thereby achieving the technical effect of dimensional diversity and manner flexibility of determining the detection result.

In another example, the light state data includes phase time information, and the phase time information includes lighting time information of the traffic lights at each phase and a lighting period duration of the traffic lights at each phase; the determining a detection result according to the first matching result may include the following steps.

A first step: determining a second degree of confidence of the phase time information according to the lighting time information in the phase time information and the lighting period duration in the phase time information.

The second degree of confidence characterizes accuracy and/or integrity of the lighting time information in the phase time information.

In some embodiments, the first step may include: determining an actual lighting duration of the traffic lights according to the lighting time information in the phase time information, computing second difference information between the actual lighting duration of the traffic lights and the lighting period duration in the phase time information, and determining the second degree of confidence according to the difference information.

In other embodiments, the first step may include: determining a second number of abnormal hopping seconds of time information of the traffic lights according to the lighting time information in the phase time information, computing a second ratio between the second number of abnormal hopping seconds and the lighting period duration in the phase time information, and determining the second degree of confidence according to the second ratio.

With regard to the implementation principles of the second difference information and the second degree of confidence, reference may be made to the implementation principles of the first difference information and the first degree of confidence in the above example, and details are not described herein again.

A second step: determining the detection result according to the first matching result and the second degree of confidence.

By the same reasoning, in the present embodiment, the detection result is determined according to the accuracy and/or the integrity of the lighting time information in the phase time information, thereby achieving the technical effect of improving the accuracy and reliability of the detection result.

It should be noted that, each embodiment in the present embodiment may be implemented separately, or may be combined into one embodiment, and when a plurality of embodiments are combined, a weight coefficient may be assigned to a matching result obtained in each embodiment, and a detection result may be determined based on each matching result and each weight coefficient.

Furthermore, the second embodiment and the third embodiment may be separate embodiments, and may also be combined into one embodiment, and the combined processing manner may refer to the foregoing description, and details are not described herein again.

It should be noted that, when the second embodiment and the third embodiment are combined into one embodiment, since the detection result is a detection result obtained by performing matching from a plurality of dimensions (namely, the period time information and the phase sequence information), the detection result has comprehensiveness, and the technical effect of further improving the accuracy and reliability of the detection result can be achieved.

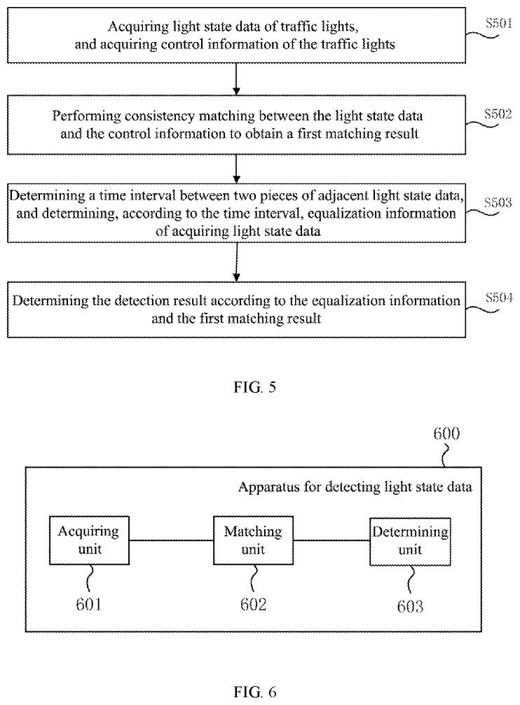

FIG. 5 is a schematic diagram according to a fourth embodiment of the present disclosure. As shown in FIG. 5, a method for detecting light state data according to an embodiment of the present disclosure includes:

S501: acquiring light state data of traffic lights, and acquiring control information of the traffic lights.

The light state data includes period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights.

S502: performing consistency matching between the light state data and the control information to obtain a first matching result.

Illustratively, with regard to implementation principles of S501 and S502, the implementation principles in any one of the foregoing embodiments may be used, and details are not described herein again.

S503: determining a time interval between two pieces of adjacent light state data, and determining, according to the time interval, equalization information of acquiring light state data.

The equalization information is used for characterizing accuracy of acquiring the light state data.

Illustratively, the detection apparatus may determine a variance or a standard deviation of the time interval, and determine the equalization information according to the variance or the standard deviation.

For example, the smaller the variance or the standard deviation is, the higher the accuracy of acquiring light state data characterized by the equalization information is; otherwise, the larger the variance or the standard deviation is, the lower the accuracy of acquiring light state data characterized by the equalization information is.

S504: determining the detection result according to the equalization information and the first matching result.

It should be noted that, in the present embodiment, due to the accuracy of acquiring the light state data can be characterized by the equalization information, therefore, when the detection result is determined in combination with the equalization information, the association between the detection result and the accuracy of acquiring light state data can be high. This is equivalent to characterizing the detection result of the light state data from more dimensions, and hence the technical effect of improving the comprehensiveness and reliability of the detection result can be achieved.

Based on the above analysis, it can be seen that, in some embodiments, the detection result of the light state data can be determined according to the light state data and the control information.

For example, the light state data may include period time information, and the detection result may be determined according to the period time information and the control information.

In another example, the light state data may include phase sequence information, and the detection result may be determined according to the phase sequence information and the control information.

In yet another example, the light state data may include the period time information and the phase sequence information, and the detection result may be determined according to the period time information, the phase sequence information, and the control information.

In another embodiment, the detection result of the light state data may be determined according to the light state data.

For example, the light state data may include period time information, and the detection result may be determined according to the period time information.

In another example, the light state data may include phase sequence information, and the detection result may be determined according to the phase sequence information.

In yet another example, the light state data may include phase time information, and the detection result may be determined according to the phase time information.

In another embodiment, the detection result may be determined according to a time interval between two pieces of adjacent light state data that is obtained.

In other embodiments, the detection result may be determined according to the light state data and the traffic network.

It should be understood that, the foregoing each example may be taken as separate embodiments, or at least part of them may be combined to obtain a new embodiment, and the specific combination manner among the each embodiment is not limited in the present embodiment.

FIG. 6 is a schematic diagram according to a fifth embodiment of the present disclosure. As shown in FIG. 6, an apparatus 600 for detecting light state data according to an embodiment of the present disclosure includes:

an acquiring unit 601, configured to acquire light state data of traffic lights, and acquire control information of the traffic lights, where the light state data includes period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights;

a matching unit 602, configured to perform consistency matching between the light state data and the control information to obtain a first matching result; and

a determining unit 603, configured to determine a detection result of the light state data according to the first matching result.

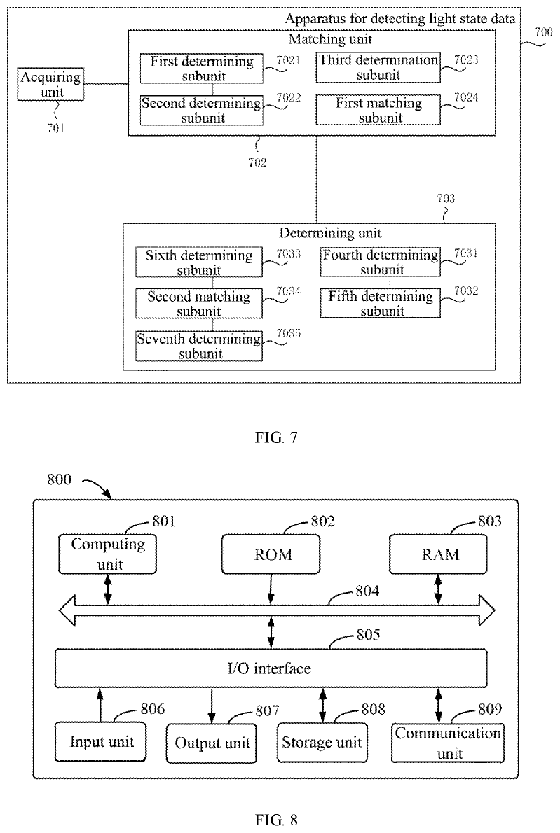

FIG. 7 is a schematic diagram according to a sixth embodiment of the present disclosure, and as shown in FIG. 7, an apparatus 700 for detecting light state data according to the embodiment of the present disclosure includes:

an acquiring unit 701, configured to acquire light state data of traffic lights, and acquire control information of the traffic lights, where the light state data includes period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and

a matching unit 702, configured to perform consistency matching on the light state data and the control information to obtain a first matching result.

In conjunction with FIG. 7, it can be seen that, in some embodiments, the light state data includes period time information, and the matching unit 702 includes:

a first determining subunit 7021, configured to determine an actual lighting duration of the traffic lights in the period time information, and determine a lighting period duration of the traffic lights in the control information; and

a second determining subunit 7022, configured to determine the first matching result based on a difference between the actual lighting duration in the period time information and the lighting period duration in the control information.

In some embodiments, if the light state data includes period time information, the matching unit 702 includes:

a first determining subunit 7021, configured to determine a lighting period duration of the traffic lights in the period time information, and determine a lighting period duration of the traffic lights in the control information; and

a second determining subunit 7022, configured to determine the first matching result based on a difference between the lighting period duration in the period time information and the lighting period duration in the control information.

In conjunction with FIG. 7, it can be seen that, in some embodiments, if the light state data includes phase sequence information, the matching unit 702 includes:

a third determination subunit 7023, configured to determine sequence information among each phase of the traffic lights in the phase sequence information, and determine sequence information among each phase of the traffic lights in the control information; and

a first matching subunit 7024, configured to perform consistency matching between the sequence information among the each phase in the phase sequence information and the sequence information among the each phase in the control information to obtain the first matching result.

In some embodiments, if the light state data includes phase sequence information, the matching unit 702 includes:

a third determining subunit 7023, configured to determine a lighting duration of each lighting color of the traffic lights in the phase sequence information, and determine a lighting duration of each lighting color of the traffic lights in the control information; and

a first matching subunit 7024, configured to perform consistency matching between the lighting duration in the phase sequence information and the lighting duration in the control information to obtain the first matching result.

The determining unit 703 is configured to determine a detection result of the light state data according to the first matching result.

In conjunction with FIG. 7, it can be seen that, in some embodiments, the period time information includes lighting time information of the traffic lights and a lighting period duration of the traffic lights; and the determining unit 703 includes:

a fourth determining subunit 7031, configured to determine a first degree of confidence of the period time information according to the lighting time information in the period time information and the lighting period duration in the period time information, where the first degree of confidence characterizes accuracy and/or integrity of the lighting time information in the period time information.

In some embodiments, the fourth determining subunit 7031 includes:

a first determining module, configured to determine an actual lighting duration of the traffic lights according to the lighting time information in the period time information; a computing module, configured to compute first difference information between the actual lighting duration of the traffic lights and the lighting period duration in the period time information; and a second determining module, configured to determine the first degree of confidence according to the first difference information; or

a first determining module, configured to determine a first number of abnormal hopping seconds of time information of the traffic lights according to the lighting time information in the period time information; a computing module, configured to compute a first ratio between the first number of abnormal hopping seconds and the lighting period duration in the period time information; and a second determining module, configured to determine the first degree of confidence according to the first ratio.

A fifth determining subunit 7032 is configured to determine the detection result according to the first matching result and the first degree of confidence.

In some embodiments, the determining unit 703 includes:

a fourth determining subunit 7031, configured to determine a time interval between two pieces of adjacent light state data, and determine, according to the time interval, equalization information of acquiring light state data, where the equalization information is used for characterizing accuracy of acquiring light state data; and

a fifth determining subunit 7032, configured to determine the detection result according to the equalization information and the first matching result.

In some embodiments, the light state data includes phase time information, and the phase time information includes lighting time information of the lights at each phase and a lighting period duration of the traffic lights at each phase; and the determining unit 703 includes:

a fourth determining subunit 7031, configured to determine a second degree of confidence of the phase time information according to the lighting time information in the phase time information and the lighting period duration in the phase time information, where the second degree of confidence characterizes accuracy and/or integrity of the lighting time information in the phase time information.

In some embodiments, the fourth determining subunit 7031 includes:

a first determining module, configured to determine an actual lighting duration of the traffic lights according to the lighting time information in the phase time information; a computing module, configured to compute second difference information between the actual lighting duration of the traffic lights and the lighting period duration in the phase time information; and a second determining module, configured to determine the second degree of confidence according to the difference information; or

a first determining module, configured to determine a second number of abnormal hopping seconds of time information of the traffic lights according to the lighting time information in the phase time information; a computing module, configured to compute a second ratio between the second number of abnormal hopping seconds and the lighting period duration in the phase time information; and a second determining module, configured to determine the second degree of confidence according to the second ratio.

A fifth determining subunit 7032 is configured to determine the detection result according to the first matching result and the second degree of confidence.

In conjunction with FIG. 7, it can be seen that in some embodiments, the determining unit 703 includes:

a sixth determining subunit 7033, configured to determine each phase in the phase sequence information, and determine each phase of the traffic lights in a preset traffic network;

a second matching subunit 7034, configured to perform consistency matching between each phase in the phase sequence information and each phase in the preset traffic network to obtain a second matching result; and

a seventh determining subunit 7035, configured to determine the detection result according to the first matching result and the second matching result.

According to an embodiment of the present disclosure, the present disclosure further provides an electronic device and a readable storage medium.

According to an embodiment of the present disclosure, the present disclosure further provides a computer program product, where the computer program product includes a computer program stored in a readable storage medium; at least one processor of an electronic device can read the computer program from the readable storage medium; and at least one processor executes the computer program to cause the electronic device to execute the solution provided by any of the above embodiments.

FIG. 8 shows a schematic block diagram of an exemplary electronic device 800 that may be configured to implement embodiments of the present disclosure. The electronic device is intended to represent various forms of digital computers, such as laptops, desktops, workstations, personal digital assistants, servers, blade servers, mainframes, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be examples only, and are not intended to limit implementations of the present disclosure described and/or claimed herein.

As shown in FIG. 8, the electronic device 800 includes a computing unit 801 that can perform various appropriate operations and processes according to a computer program stored in a read-only memory (ROM) 802 or a computer program loaded from a storage unit 808 into a random access memory (RAM) 803. In the RAM 803, various programs and data required for operations of the device 800 may also be stored. The computing unit 801, the ROM 802, and the RAM 803 are connected to each other through a bus 804. An input/output (I/O) interface 805 is also connected to the bus 804.

A plurality of components of the device 800 are connected to the I/O interface 805, including an input unit 806, such as a keyboard, a mouse, and the like; an output unit 807, such as various types of displays, speakers, and the like; a storage unit 808, such as a magnetic disk, an optical disk, and the like; and a communication unit 809, such as a network card, a modem, a wireless communication transceiver, and the like. The communication unit 809 allows the device 800 to exchange information/data with other devices through a computer network such as the Internet and/or various telecommunication networks.

The computing unit 801 may be a variety of general and/or specific processing components with processing and computing capabilities. Some examples of the computing unit 801 include, but are not limited to, a central processing unit (CPU), a graphics processing unit (GPU), various specific artificial intelligence (AI) computing chips, various computing units running machine learning model algorithms, a digital signal processor (DSP), and any suitable processor, controller, microcontroller, etc. The computing unit 801 performs the various methods and processes described above, for example, the method for detecting light state data. For example, in some embodiments, the method for detecting light state data may be implemented as a computer software program contained in a machine-readable medium tangibly, such as the storage unit 808. In some embodiments, some or all of the computer programs may be loaded and/or installed into the device 800 via the ROM 802 and/or the communication unit 809. When the computer program is loaded into the RAM 803 and executed by the computing unit 801, one or more steps of the method for detecting light state data described above may be performed. Alternatively, in other embodiments, the computing unit 801 may be configured to perform the method for detecting light state data in any other suitable manner (e.g. by means of firmware).

Various implementations of the systems and techniques described above herein can be realized in a digital electronic circuit system, an integrated circuit system, field programmable gate arrays (FPGA), application specific integrated circuits (ASIC), application specific standard products (ASSP), a system-on-chip system (SOC), a complex programming logic device (CPLD), a computer hardware, a firmware, software, and/or their combinations. These various implementations may include an implementation implemented in one or more computer programs that are executable and/or interpretable in a programmable system including at least one programmable processor. The programmable processor may be specific or general programmable processor, and may receive data and instructions from, and transmit data and instructions to, a storage system, at least one input apparatus, and at least one output apparatus.

Program codes for implementing the method of the present disclosure may be written in any combination of one or more programming languages. These program codes may be provided to a processor or a controller of a general computer, a specific computer or other programmable data processing apparatuses causing the functions/operations specified in the flowchart and/or block diagram to be implemented when the program codes are executed by the processor or the controller. The program codes may be executed entirely by the machine, partially by the machine, partially by the machine as a stand-alone software package and partially by a remote machine or entirely by a remote machine or server.

In the context of the present disclosure, a machine readable medium may be a tangible medium that may contain or store a program for use by an instruction execution system, apparatus, or device or a program for use in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include electrical connections based on one or more wires, portable computer disks, hard disks, a random access memory (RAM), a read only memory (ROM), an erasable programmable read only memory (EPROM or a flash memory), optical fibers, a compact disk read only memory (CD-ROM), optical storage devices, magnetic storage devices, or any suitable combination of the foregoing.

To provide for interaction with a user, the systems and techniques described here can be implemented on a computer. The computer has: a display apparatus (e.g. a CRT (cathode ray tube) or an LCD (liquid crystal display) monitor) for displaying information to a user; and a keyboard and a pointing apparatus (e.g. a mouse or a trackball). A user may provide input to the computer through the keyboard and the pointing apparatus. Other kinds of apparatuses may also be used to provide for interaction with the user. For example, feedback provided to the user can be any form of sensory feedback (e.g. visual feedback, auditory feedback, or tactile feedback). And input from the user can be received in any form (including acoustic, speech, or tactile input).

The systems and techniques described here can be implemented in a computing system that includes a back-end component (e.g. as a data server), or a computing system that includes a middleware component (e.g. an application server), or a computing system that includes a front-end component (e.g. a user computer having a graphical user interface or a web browser through which a user can interact with an implementation of the systems and techniques described herein), or a computing system that includes any combination of such back-end, middleware, or front-end components. The components of the systems can be interconnected by any form or medium of digital data communication (e.g. a communication network). Examples of communication networks include: local area networks (LANs), wide area networks (WAN), and the Internet.

A computer system may include a client and a server. The client and the server are generally located remotely from each other and typically interact through a communication network. The relationship of client and server arises by virtue of computer programs running on respective computers and having a client-server relationship therebetween. The server can be a cloud server, which is also referred to as a cloud computing server or a cloud host, and it is a host product in a cloud computing service system to solve shortcomings of difficult management and weak business scalability existing in a traditional physical host and a VPS (Virtual Private Server) service. The server can also be a server of a distributed system, or a server combined with a blockchain.

It should be appreciated that, steps may be reordered, added, or deleted according to the various processes described above. For example, the steps described in the present application may be executed in parallel, sequentially, or in different orders, which are not limited herein as long as the desired results of the technical solutions provided in the present disclosure can be achieved.

The foregoing specific implementations do not constitute a limitation to the extent of protection of the present disclosure. A person skilled in the art may appreciate that various modifications, combinations, sub-combinations and substitutions can be made according to design requirements and other factors. Any modifications, equivalent substitutions and improvements and the like made within the spirit and the principle of the present disclosure should be all included within the scope of protection of the present disclosure.

What is claimed is:

1. A method for detecting light state data, comprising:
acquiring light state data of traffic lights, and acquiring control information of the traffic lights, wherein the light state data comprises period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and
performing consistency matching between the light state data and the control information to obtain a first matching result, and determining a detection result of the light state data according to the first matching result.

2. The method according to claim 1, wherein if the light state data comprises period time information, the performing consistency matching between the light state data and the control information to obtain a first matching result comprises:
determining an actual lighting duration of the traffic lights in the period time information, and determining a lighting period duration of the traffic lights in the control information; and
determining the first matching result based on a difference between the actual lighting duration in the period time information and the lighting period duration in the control information.

3. The method according to claim 1, wherein if the light state data comprises period time information, the performing consistency matching between the light state data and the control information to obtain a first matching result comprises:
determining a lighting period duration of the traffic lights in the period time information, and determining a lighting period duration of the traffic lights in the control information; and
determining the first matching result based on a difference between the lighting period duration in the period time information and the lighting period duration in the control information.

4. The method according to claim 1, wherein if the light state data comprises phase sequence information, the performing consistency matching between the light state data and the control information to obtain a first matching result comprises:
determining sequence information among each phase of the traffic lights in the phase sequence information, and determining sequence information among each phase of the traffic lights in the control information; and
performing consistency matching between the sequence information among the each phase in the phase sequence information and the sequence information among the each phase in the control information to obtain the first matching result.

5. The method according to claim 1, wherein if the light state data comprises phase sequence information, the performing consistency matching between the light state data and the control information to obtain a first matching result comprises:
determining a lighting duration of each lighting color of the traffic lights in the phase sequence information, and determining a lighting duration of each lighting color of the traffic lights in the control information; and
performing consistency matching between the lighting duration in the phase sequence information and the lighting duration in the control information to obtain the first matching result.

6. The method according to claim 1, wherein the period time information comprises lighting time information of the traffic lights and a lighting period duration of the traffic lights; the determining a detection result of the light state data according to the first matching result comprises:
determining a first degree of confidence of the period time information according to the lighting time information in the period time information and the lighting period duration in the period time information, wherein the first degree of confidence characterizes accuracy and/or integrity of the lighting time information in the period time information; and
determining the detection result according to the first matching result and the first degree of confidence.

7. The method according to claim 6, wherein the determining a first degree of confidence of the period time information according to the lighting time information in the period time information and the lighting period duration in the period time information comprises:
determining an actual lighting duration of the traffic lights according to the lighting time information in the period time information, computing first difference information between the actual lighting duration of the traffic lights and the lighting period duration in the period time information, and determining the first degree of confidence according to the first difference information;
or,
determining a first number of abnormal hopping seconds of time information of the traffic lights according to the lighting time information in the period time information, computing a first ratio between the first number of abnormal hopping seconds and the lighting period duration in the period time information, and determining the first degree of confidence according to the first ratio.

8. The method according to claim 1, wherein the determining a detection result of the light state data according to the first matching result comprises:
determining a time interval between two pieces of adjacent light state data, and determining, according to the time interval, equalization information of acquiring the light state data, wherein the equalization information is used for characterizing accuracy of acquiring the light state data; and
determining the detection result according to the equalization information and the first matching result.

9. The method according to claim 2, wherein the determining a detection result of the light state data according to the first matching result comprises:
determining a time interval between two pieces of adjacent light state data, and determining, according to the time interval, equalization information of acquiring the light state data, wherein the equalization information is used for characterizing accuracy of acquiring the light state data; and
determining the detection result according to the equalization information and the first matching result.

10. The method according to claim 3, wherein the determining a detection result of the light state data according to the first matching result comprises:
determining a time interval between two pieces of adjacent light state data, and determining, according to the time interval, equalization information of acquiring the light state data, wherein the equalization information is used for characterizing accuracy of acquiring the light state data; and
determining the detection result according to the equalization information and the first matching result.

11. The method according to claim 4, wherein the determining a detection result of the light state data according to the first matching result comprises:
determining a time interval between two pieces of adjacent light state data, and determining, according to the time interval, equalization information of acquiring the light state data, wherein the equalization information is used for characterizing accuracy of acquiring the light state data; and
determining the detection result according to the equalization information and the first matching result.

12. The method according to claim 5, wherein the determining a detection result of the light state data according to the first matching result comprises:
determining a time interval between two pieces of adjacent light state data, and determining, according to the time interval, equalization information of acquiring the light state data, wherein the equalization information is used for characterizing accuracy of acquiring the light state data; and
determining the detection result according to the equalization information and the first matching result.

13. The method according to claim 1, wherein the determining a detection result of the light state data according to the first matching result comprises:
determining each phase in the phase sequence information, and determining each phase of the traffic lights in a preset traffic network, and performing consistency matching between each phase in the phase sequence information and each phase in the preset traffic network to obtain a second matching result; and
determining the detection result according to the first matching result and the second matching result.

14. The method according to claim 2, wherein the determining a detection result of the light state data according to the first matching result comprises:
determining each phase in the phase sequence information, and determining each phase of the traffic lights in a preset traffic network, and performing consistency matching between each phase in the phase sequence information and each phase in the preset traffic network to obtain a second matching result; and
determining the detection result according to the first matching result and the second matching result.

15. The method according to claim 3, wherein the determining a detection result of the light state data according to the first matching result comprises:
determining each phase in the phase sequence information, and determining each phase of the traffic lights in a preset traffic network, and performing consistency matching between each phase in the phase sequence information and each phase in the preset traffic network to obtain a second matching result; and
determining the detection result according to the first matching result and the second matching result.

16. The method according to claim 4, wherein the determining a detection result of the light state data according to the first matching result comprises:
determining each phase in the phase sequence information, and determining each phase of the traffic lights in a preset traffic network, and performing consistency matching between each phase in the phase sequence information and each phase in the preset traffic network to obtain a second matching result; and
determining the detection result according to the first matching result and the second matching result.

17. The method according to claim 1, wherein the light state data comprises phase time information, and the phase time information comprises: lighting time information of the traffic lights at each phase, and a lighting period duration of the traffic lights at each phase; the determining a detection result of the light state data according to the first matching result comprises:
determining a second degree of confidence of the phase time information according to the lighting time information in the phase time information and the lighting period duration in the phase time information, wherein the second degree of confidence characterizes accuracy and/or integrity of the lighting time information in the phase time information; and
determining the detection result according to the first matching result and the second degree of confidence.

18. The method according to claim 17, wherein the determining a second degree of confidence of the phase time information according to the lighting time information in the phase time information and the lighting period duration in the phase time information comprises:
determining an actual lighting duration of the traffic lights according to the lighting time information in the phase time information, computing second difference information between the actual lighting duration of the traffic lights and the lighting period duration in the phase time information, and determining the second degree of confidence according to the difference information;
or,
determining a second number of abnormal hopping seconds of time information of the traffic lights according to the lighting time information in the phase time information, computing a second ratio between the second number of abnormal hopping seconds and the lighting period duration in the phase time information, and determining the second degree of confidence according to the second ratio.

19. An electronic device, comprising:
at least one processor; and
a memory communicatively coupled to the at least one processor; wherein
the memory stores instructions executable by the at least one processor, and the instructions are executed by the at least one processor to enable the at least one processor to:
acquire light state data of traffic lights, and acquire control information of the traffic lights, wherein the light state data comprises period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and
perform consistency matching between the light state data and the control information to obtain a first matching result, and determine a detection result of the light state data according to the first matching result.

20. A non-transitory computer readable storage medium storing computer instructions, wherein the computer instructions are used for causing a computer to:
acquire light state data of traffic lights, and acquire control information of the traffic lights, wherein the light state data comprises period time information and/or phase sequence information, the period time information characterizes time information of lighting each light holder in the traffic lights in a period, the phase sequence information characterizes a green light order of each phase corresponding to the traffic lights, and the control information characterizes a control rule of the traffic lights; and
perform consistency matching between the light state data and the control information to obtain a first matching result, and determine a detection result of the light state data according to the first matching result.
